(19) United States
(12) Patent Application Publication
(10) Pub. No.: US 2005/0059757 A1
(43) Pub. Date: Mar. 17, 2005

(54) Absorbent fillers for three-dimensional printing

(75) Inventors: James F. Bredt, Watertown, MA (US); Derek X. Williams, Exeter, NH (US); Sarah L. Clark, Somerville, MA (US); Matthew J. DiCologero, Stoneham, MA (US); William B. Shambley, Billerica, MA (US); Laura Tennenhouse, Arlington, MA (US)

Correspondence Address: TESTA, HURWITZ & THIBEAULT, LLP, HIGH STREET TOWER, 125 HIGH STREET, BOSTON, MA, 02110, US

(73) Assignee: Z Corporation, Burlington, MA (US)

(21) Appl. No.: 10/926,172

(22) Filed: Aug. 25, 2004

Related U.S. Application Data
(60) Provisional application No. 60/499,220, filed on Aug. 29, 2003.

(51) Int. Cl. C04B 14/00; C08K 3/00

(52) U.S. Cl. 524/3; 106/401; 106/425; 106/427; 106/429; 106/464; 106/468; 106/461; 106/462; 106/470; 106/482; 106/483; 106/486; 106/489; 106/499; 106/501.1; 106/459; 106/456; 106/453; 106/454; 106/436; 106/443; 106/311

(57) ABSTRACT

A materials system and methods are provided to enable the formation of articles by three-dimensional printing. The materials system includes an absorbent particulate filler that facilitates absorption of infiltrants, thereby allowing the accurate definition of articles with enhanced mechanical and structural characteristics. The methods include the use of phase-change materials to bind a powder, as well as the formation of support structures to improve the control of the shape of the articles.

### RELATED APPLICATIONS

This application claims the benefit of U.S. Provisional Application 60/499,220 filed Aug. 29, 2003, the entire disclosure of which is hereby incorporated by reference.

### FIELD OF THE INVENTION

This invention relates generally to rapid prototyping techniques and, more particularly, to a three-dimensional printing material and method using particulate mixtures containing absorbent fillers.

### BACKGROUND

The field of rapid prototyping involves the production of prototype articles and small quantities of functional parts, as well as structural ceramics and ceramic shell molds for metal casting, directly from computer-generated design data.

Two well-known methods for rapid prototyping include a selective laser sintering process and a liquid binder three-dimensional printing process. These techniques are similar, to the extent that they both use layering techniques to build three-dimensional articles. Both methods form successive thin cross-sections of the desired article. The individual cross-sections are formed by bonding together adjacent grains of a granular material on a generally planar surface of a bed of the granular material. Each layer is bonded to a previously formed layer to form the desired three-dimensional article at the same time as the grains of each layer are bonded together. The laser-sintering and liquid binder techniques are advantageous, because they create parts directly from computer-generated design data and can produce parts having complex geometries. Moreover, three-dimensional printing can be quicker and less expensive than machining of prototype parts or production of cast or molded parts by conventional “hard” or “soft” tooling techniques, that can take from a few weeks to several months, depending on the complexity of the item.

Three-dimensional printing has been used to make ceramic molds for investment casting, to produce fully functional cast metal parts. Additional uses are contemplated for three-dimensional printing. For example, three-dimensional printing may be useful in design-related fields for visualization, demonstration, and mechanical prototyping. It may also be useful for making patterns for molding processes. Three-dimensional printing techniques may be further useful, for example, in the fields of medicine and dentistry, where expected outcomes may be modeled prior to performing procedures. Other businesses that may benefit from rapid prototyping technology include architectural firms, as well as others in which visualization of a design is useful.

A selective laser sintering process is described in U.S. Pat. No. 4,863,568, incorporated herein by reference in its entirety. The selective laser sintering process has been commercialized by DTM Corporation, now 3D Systems. The selective laser sintering process involves spreading a thin layer of powder onto a flat surface. The powder is spread using a tool developed for use with the selective laser sintering process, known in the art as a counter-rolling mechanism or counter-roller. Using the counter-roller allows thin layers of material to be spread relatively evenly, without disturbing previous layers. After the layer of powder is spread onto the surface, a laser is used to direct laser energy onto the powder in a predetermined two-dimensional pattern. The laser sinters or fuses the powder together in the areas impinged upon by the laser beam energy. The powder may be plastic, metal, polymer, ceramic or a composite. Successive layers of powder are spread over previous layers using the counter-roller, followed by sintering or fusing with the laser. The process is essentially thermal, requiring delivery by the laser of a sufficient amount of energy to sinter the powder together, and to previous layers, to form the final article.

An early three-dimensional printing technique, described in U.S. Pat. No. 5,204,055, incorporated herein by reference in its entirety, describes the use of an ink-jet style printing head to deliver a liquid or colloidal binder material to sequentially applied layers of powdered material. The three-dimensional ink-jet printing technique or liquid binder method involves applying a layer of a powdered material to a surface using a counter-roller. After the powdered material is applied to the surface, the ink-jet printhead delivers a liquid binder in a predetermined pattern to the layer of powder. The binder infiltrates into gaps in the powder material and hardens to bond the powder material into a solidified layer. The hardened binder also bonds each layer to the previous layer. After the first cross-sectional portion is formed, the previous steps are repeated, building successive cross-sectional portions until the final article is formed. Optionally, an adhesive can be suspended in a carrier that evaporates, leaving the hardened adhesive behind. The powdered material may be ceramic, metal, plastic or a composite material, and may also include fibers. The liquid binder material may be organic or inorganic. Typical organic binder materials used are polymeric resins or ceramic precursors, such as polycarbosilazane. Inorganic binders are used where the binder is incorporated into the final articles; silica is typically used in such an application.

One advantage of using an ink-jet print head, rather than a laser, is that a plurality of spray nozzles used to deliver binder to the powder may be arranged side-by-side in a single print head. In selective laser sintering machines, only one laser is conventionally used to deliver energy to the powder. The combination of several spray nozzles increases the speed of liquid binder printing in comparison to laser-sintering, by allowing a larger area to be printed at one time. In addition, liquid binder printing equipment is much less expensive than the laser equipment, due to the high cost of the laser and the high cost of the related beam deflection optics and controls.

The powders, especially metallic powders, presently used in both selective laser sintering and liquid binder techniques present safety issues that may render them undesirable for use in an office environment. These safety issues may require special clothing and processing facilities to prevent, for example, skin contact or inhalation of toxic materials. In addition, more expense may be incurred through complying with regulations for the disposal of toxic materials. For these reasons, these techniques do not lend themselves to being used in typical office environments, such as architectural and design firms, or doctors' offices.

Another three-dimensional printing technique, described in U.S. Pat. Nos. 5,902,441 and 6,416,850, both references incorporated herein by reference in their entirety, utilizes a powder mixture containing a filler and an activatable adhesive in conjunction with an aqueous fluid that activates the adhesive to bind the filler. The fluid is applied by an ink-jet printhead. The filler and adhesive may each include non-toxic materials such as, for example, water-soluble polymers, carbohydrates, sugars, sugar alcohols, proteins, and some inorganic compounds.

There exists a need in the art for a materials system and method that enables the quick, reliable, safe, and inexpensive fabrication of appearance models and small batches of functional parts in an office environment. Such appearance models and parts should have good-quality surfaces, be accurately defined, and be strong without being brittle. Furthermore, some kinds of models need specific mechanical properties, such as flexibility for snap-fits or impact toughness.

### SUMMARY

The present invention is directed to a materials system and method that satisfies the need for a quick, reliable, safe, and inexpensive method for producing both appearance models and small numbers of functional parts in an office environment. The materials system includes an absorbent particulate filler material suitable for absorbing an infiltrant, allowing the fabrication of appearance models and functional parts that are geometrically accurately defined, are strong and tough without being brittle, have smooth surface finishes with, optionally, thin walls, and are capable of being snap-fitted together.

In one aspect, the invention features a powder for three-dimensional printing. The powder includes an absorbent filler and a reactive filler.

One or more of the following features may be included. The absorbent filler may include powdered amorphous cellulose, powdered microcrystalline cellulose, polyamide powder, porous poly-methylmethacrylate powder, ethylene-propylene-diene-monomer (EPDM) powder, zinc oxide, magnesium oxide, calcium sulfate, calcium carbonate, poly condensate of urea-formaldehyde, surface modified ultra high molecular weight polyethylene powder, surface modified high density polyethylene powder, methylenediaminomethylether polycondensate, maltodextrin, aluminum oxide, soda-lime glass, borosilicate glass, amorphous silica, aluminosilicate ceramic, clays such as montmorillonite and kaolin, fly ash, silica gel, aluminosilicate zeolites, pigment grade ceramics such as iron oxide, chromic oxide, titanium dioxide, and/or combinations thereof.

The absorbent filler may include a material having an oil absorption capacity within a range of about 30 grams to about 500 grams of oil per 100 grams of absorbent filler. The absorbent filler may include a material that is chemically active with an infiltrant.

The absorbent filler may include a chemically modified absorbent filler including a chemically modified glass bead, a chemically modified polyamide powder, a chemically modified polyethylene powder, and/or combinations thereof. The chemically modified glass bead may include an amino group, an epoxy group, and/or combinations thereof. At least one of the chemically modified polyamide powder and the polyethylene powder may include a carboxylic acid group.

The reactive filler may include plaster, portland cement, magnesium phosphate cement, magnesium oxychloride cement, magnesium oxysulfate cement, zinc phosphate cement, zinc eugenol cement, and/or combinations thereof.

The powder may include an adhesive, such as a water-soluble polymer, a carbohydrate, a sugar, a sugar alcohol, an organic acid, a protein, an inorganic compound, and/or combinations thereof. The water-soluble polymer may include polyvinyl alcohol, sulfonated polystyrene, sulfonated polyester, polyethylene oxide, polyacrylic acid, octylacrylamide/acrylate/butylaminoethyl methacrylate copolymer, acrylates/octylarylamide copolymer, polyvinyl pyrrolidone, styrenated polyacrylic acid, polyethylene oxide, sodium polyacrylate, sodium polyacrylate copolymer with maleic acid, polyvinyl pyrrolidone copolymer with vinyl acetate, butylated polyvinylpyrrolidone, polyvinyl alcohol-co-vinyl acetate, starch, modified starch, cationic starch, pregelatinized starch, pregelatinized modified starch, pregelatinized cationic starch, and/or combinations and copolymers thereof.

The powder may include a salt, such as, for example, terra alba, potassium sulfate, sodium chloride, undercalcined plaster, alum, potassium alum, lime, calcined lime, barium sulfate, magnesium sulfate, zinc sulfate, calcium chloride, calcium formate, calcium nitrate, sodium silicate, magnesium sulfate monohydrate, potassium, sodium, and ammonium sulfates and chlorides, sodium tetraborate decahydrate, sodium tetraborate pentahydrate, sodium tetraborate anhydrous, zinc borate, boric acid, and combinations thereof.

In another aspect, the invention features a method for forming an article by three-dimensional printing. The method includes providing a layer including a powder having a plurality of adjacent particles; and applying to at least some of the plurality of particles a phase-change material including a thermoplastic material. The thermoplastic material is adapted to (i) undergo a phase change at a temperature greater than ambient temperature, and (ii) solidify at ambient temperature, thereby binding those particles to form the article.

One or more of the following features may be included. The thermoplastic material may include a urethane, a polyamide, a polyester, an ethylene vinyl acetate, parrafin, a polyethylene wax, a polyolefin wax, a styrene-isoprene-isoprene copolymer, a styrene-butadiene-styrene copolymer, an ethylene ethyl acrylate copolymer, a polyoctenamer, a polycaprolactone, an alkyl cellulose, a hydroxy alkyl cellulose, a polyethylene/polyolefin copolymer, a maleic anhydride grafted polyethylene or polyolefin, an oxidized polyethylene, a potassium or lithium salt of an oxidized polyethylene, a urethane derivitized oxidized polyethylene, a long chain primary alcohol, a long chain carboxylic acid, a branched polyolefin, an unsaturated polyolefin, and/or combinations thereof. The polyolefin wax may include a polypropylene wax.

In another aspect, the invention features a method for forming an article by three-dimensional printing. The method includes providing a layer including a powder comprising a plurality of adjacent particles, the powder including an absorbent filler. The absorbent filler may include powdered amorphous cellulose, powdered microcrystalline cellulose, polyamide powder, porous poly-methylmethacrylate powder, ethylene-propylene-diene-monomer (EPDM) powder, zinc oxide, magnesium oxide, calcium sulfate, calcium carbonate, poly condensate of urea-formaldehyde, surface modified ultra high molecular weight polyethylene powder, surface modified high density polyethylene powder, methylenediaminomethylether polycondensate, maltodextrin, aluminum oxide, soda-lime glass, borosilicate glass, amorphous silica, aluminosilicate ceramic, clays such as montmorillonite and kaolin, fly ash, silica gel, aluminosilicate zeolites, pigment grade ceramics such as iron oxide, chromic oxide, titanium dioxide, and/or combinations thereof. A fluid is applied to at least some of the plurality of particles in an amount sufficient to bond those particles together to define the article.

In another aspect, the invention features a method for forming a substantially solid article by three-dimensional printing. The method includes providing a layer including a powder comprising a plurality of adjacent particles. A fluid is applied to at least some of the plurality of particles in an amount sufficient to bond those particles together to define a porous singular intermediate article. The intermediate article is infiltrated with an infiltrant to define the substantially solid final article having approximately 20%-70% infiltrant by volume.

One or more of the following features may be included. The powder may contain an absorbent filler, such as powdered amorphous cellulose, powdered microcrystalline cellulose, polyamide powder, porous poly-methylmethacrylate powder, ethylene-propylene-diene-monomer (EPDM) powder, zinc oxide, magnesium oxide, calcium sulfate, calcium carbonate, poly condensate of urea-formaldehyde, surface modified ultra high molecular weight polyethylene powder, surface modified high density polyethylene powder, methylenediaminomethylether polycondensate, maltodextrin, aluminum oxide, soda-lime glass, borosilicate glass, amorphous silica, aluminosilicate ceramic, clays such as montmorillonite and kaolin, fly ash, silica gel, aluminosilicate zeolites, pigment grade ceramics such as iron oxide, chromic oxide, titanium dioxide, and/or combinations thereof.

The absorbent filler may have an oil absorption capacity selected from the range of about 30 grams of oil per 100 grams of material to about 500 grams of oil per 100 grams of material, more preferably selected from the range of about 200 grams of oil per 100 grams of material to about 400 grams of oil per 100 grams of material, and even more preferably selected from the range of about 250 grams of oil per 100 grams of material to about 350 grams of oil per 100 grams of material.

The powder may include a reactive filler. The particles may have a mean diameter of about 10 micrometers to about 100 micrometers.

In another aspect, the invention features a method for forming a substantially solid article by three-dimensional printing. The method includes providing a layer of a powder having a plurality of adjacent particles. A fluid is applied to at least some of the plurality of particles in an amount sufficient to bond those particles together to define a porous singular intermediate article and a support structure adapted to support the intermediate article. The intermediate article is infiltrated with an infiltrant to define the substantially solid final article while the intermediate article is supported by the support structure.

One or more of the following features may be included. The support structure may be separated from the intermediate article, e.g., subsequent to infiltration of the intermediate article with the infiltrant. A surface of the support structure may be coated with a material adapted to facilitate separation of the support structure from the infiltrated intermediate article. The intermediate article may be heat treated while the intermediate article is supported by the support structure. The support structure may be separated from the substantially solid final article.

In another aspect, the invention features a substantially solid article including a conglomerate of a powder and a fluid that binds the powder to define a porous structure, and an infiltrant disposed within the porous structure to form the substantially solid article having about 20% to about 70% infiltrant by volume. The article includes a plurality of adjacent layers formed by the conglomerate of powder and the fluid, each layer having a contour defining an edge, and a final shape of the article being defined by respective edges of the layers.

One or more of the following features may be included. The powder may include an absorbent filler material. The powder may include a reactive filler material.

In another aspect, the invention features an activating fluid for three-dimensional printing, the fluid including a first solvent, a second solvent, and a biocide.

The following feature may be included. The biocide may include chlorine, a chlorine compound, iodine, an iodine compound, a peroxygen compound, ozone, chlorine dioxide, alcohol, a phenolic compound, a surfactant, chlorhexidine, glutaraldehyde, a nitrogen compound, a paraben, an isothiozolinone, and/or combinations thereof.

These and other features, aspects and advantages of the present invention will become better understood with reference to the following description and appended claims.

### BRIEF DESCRIPTION OF THE DRAWINGS

The following drawings are not necessarily to scale, emphasis instead being placed generally upon illustrating the principles of the invention. The foregoing and other features and advantages of the present invention, as well as the invention itself, will be more fully understood from the following description of exemplary and preferred embodiments, when read together with the accompanying drawings, in which:

FIG. 1 is a schematic view of a first layer of a mixture of particulate material of an embodiment of the invention deposited onto a downwardly movable surface of a container on which an article is to be built, before any fluid has been delivered;

FIG. 2 is a schematic view of an ink-jet nozzle delivering a fluid to a portion of the layer of particulate material of FIG. 1 in a predetermined pattern;

FIG. 3 is a schematic view of a final article of an embodiment of the invention enclosed in the container, the article made by a series of steps illustrated in FIG. 2 and still immersed in the loose unactivated particles;

FIG. 4 is a schematic view of the final article of FIG. 3;

FIGS. 5a-5g are schematic views illustrating an article and a support structure fabricated in conjunction with the article by three-dimensional printing; and

FIGS. 6a-6f and 7a-7d are schematic views illustrating an article having portions that snap fit together.

### DETAILED DESCRIPTION

The present invention relates to a three-dimensional printing material system including a mixture of particles of absorbent filler material and a reactive filler, an adhesive, and/or a salt and a fluid to bind the absorbent particulate filler material to form an essentially solid porous article capable of absorbing an infiltrant. The present invention also relates to a method of use for such a materials system, and to an article made by the method of the invention. The article of the invention may be formed with excellent accuracy and an exceptional surface finish. A support structure may be formed in conjunction and simultaneously with the article, to provide physical support to the article during fabrication. As used herein, “intermediate article” is meant to define a product of a three-dimensional printing process before infiltration by an infiltrant. “Infiltrated article” is meant to define the product of a three-dimensional printing process after infiltration by an infiltrant. “Absorbent filler material” is meant to define a filler component that is capable of absorbing an infiltrant. The absorbent filler is solid prior to application of an activating fluid, is generally substantially less soluble in the fluid than an adhesive, and provides increased flexibility and infiltrant retention to the intermediate article. “Adhesive” is meant to define a component that forms a structural mechanical bridge between components of a network, such as particles, that were separate prior to activation by a fluid, e.g., the absorbent filler material. The formation of the mechanical bridge results in the formation of a solid structure. “Filler” is meant to define a component that is solid prior to application of the activating fluid, that is generally substantially less soluble in the fluid than the adhesive, and that provides structural integrity to the final article. Fillers in addition to the absorbent filler material may be used, such as various inorganic or organic materials. “Reactive filler” is meant to define a component that enables short term hardening of a printed region. “Bond” is meant to define the building of a structural mechanical bridge between separate particles to form a network. “Infiltrant” is meant to define a liquid resin designed to impregnate an intermediate article composed of an absorbent filler and other particulate components.

The particulate mixture may include reinforcing fibers or a reinforcing fibrous component, added to provide structural reinforcement to the final article. As used herein, “fiber” or “fibrous component” is meant to define a component that is solid prior to application of the activating fluid, which may be advantageously, but not necessarily, insoluble in the fluid. The fiber or fibrous component may be added to increase the final article strength. In some embodiments, a stabilizing fiber may be added to the filler to provide dimensional stability to the final article, to control the migration of liquid through the bulk powder, and to increase slightly the article strength.

A fiber is a solid component whose primary grains have an average length that is at least 3-4 times longer than their average cross-sectional dimensions. Such materials are common in industry. For the purposes of three-dimensional printing, fibers are generally useful in a restricted size range, i.e., approximately the thickness of spread layers of powder and smaller.

In some embodiments, a processing aid compound, such as a viscous liquid that serves as a printing aid, may be added to the particulate mixture to prevent or minimize geometric distortions in printing. The processing aid prevents fine particles of the mixture from becoming airborne while the liquid is dispensed from the printhead, which could distort the printed article from the desired geometric configuration.

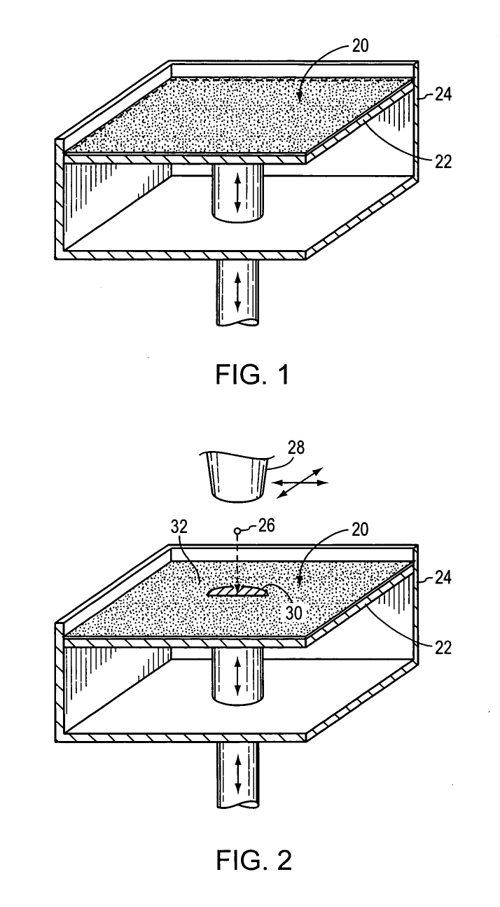

Referring to FIG. 1, in accordance with a printing method using the materials system of the present invention, a layer or film of a particulate material 20, i.e., a powder, is applied on a linearly movable surface 22 of a container 24. The layer or film of particulate material 20 may be formed in any suitable manner, for example using a counter-roller. The particulate material 20 applied to the surface includes an absorbent filler material and a reactive filler material. The particulate material 20 may also include an adhesive, an additional filler material, a processing aid material, and/or a fibrous material.

Referring to FIG. 2, an ink-jet style nozzle 28 delivers an activating fluid 26 to at least a portion 30 of the layer or film of the particulate mixture 20 in a two-dimensional pattern. According to the printing method, the fluid 26 is delivered to the layer or film of particulate material 20 in any predetermined two-dimensional pattern (circular, in the figures, for purposes of illustration only), using any convenient mechanism, such as a drop-on-demand (DOD) printhead driven by software in accordance with article model data from a computer-assisted-design (CAD) system.

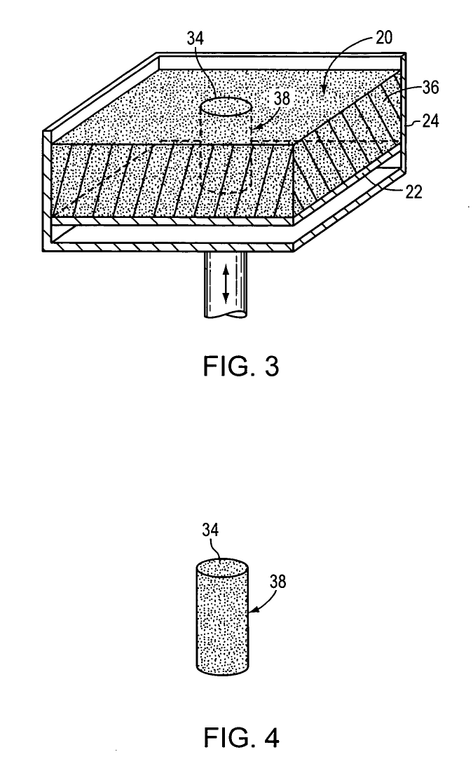

The first portion 30 of the particulate mixture is activated by the fluid 26, causing the activated particles to adhere together to form a conglomerate of the particulate material 20 (powder) and fluid 26. The conglomerate defines an essentially solid circular layer that becomes a cross-sectional portion of an intermediate article 38 (see, e.g., FIGS. 3 and 4). As used herein, “activates” is meant to define a change in state from essentially inert to adhesive. This definition encompasses the activation of the adhesive particulate material to bond the absorbent filler particulate material. When the fluid initially comes into contact with the particulate mixture, it immediately flows outwardly (on a microscopic scale) from the point of impact by capillary suction, dissolving the adhesive within a relatively short time period, such as the first few seconds. A typical droplet of activating fluid has a volume of about 40 picoliters (pl), and spreads to a diameter of about 100 μm after coming into contact with the particulate mixture. As the solvent dissolves the adhesive, the fluid viscosity increases dramatically, arresting further migration of the fluid from the initial point of impact. Within a few minutes, the fluid with adhesive dissolved therein infiltrates the less soluble and slightly porous particles, forming adhesive bonds between the absorbent filler particulate material as well as between the additional filler and the fiber. The activating fluid is capable of bonding together an amount of the particulate mixture that is several times the mass of a droplet of the fluid. As volatile components of the fluid evaporate, the adhesive bonds harden, joining the absorbent filler particulate material and, optionally, additional filler and fiber particulates into a rigid structure, which becomes a cross-sectional portion of the final article 40.

Any unactivated particulate mixture 32 that was not exposed to the fluid remains loose and free-flowing on the movable surface 22. The unactivated particulate mixture is typically left in place until formation of the intermediate article 38 is complete. Leaving the unactivated, loose particulate mixture in place ensures that the intermediate article 38 is fully supported during processing, allowing features such as overhangs, undercuts, and cavities to be defined and formed without the need to use supplemental support structures. After formation of the first cross-sectional portion of the intermediate article 38, the movable surface 22 is indexed downwardly, in this embodiment, and the process is repeated.

Using, for example, a counter-rolling mechanism, a second film or layer of the particulate mixture is then applied over the first layer, covering both the rigid first cross-sectional portion, and any proximate loose particulate mixture. A second application of fluid follows in the manner described above, dissolving the adhesive and forming adhesive bonds between at least a portion of the previous cross-sectional formed portion, the absorbent filler particulate material, and, optionally, additional filler and fiber of the second layer, and hardening to form a second rigid cross-sectional portion added to the first rigid cross-sectional portion of the final article. The movable surface 22 is again indexed downward.

The previous steps of applying a layer of particulate mixture, including the adhesive, applying the activating fluid, and indexing the movable surface 22 downward are repeated until the intermediate article 38 is completed. Referring to FIG. 3, the intermediate article 38 may be any shape, such as cylindrical. At the end of the process, only a top surface 34 of the intermediate article 38 is visible in the container 24. The intermediate article 38 is typically completely immersed in a surrounding bed 36 of unactivated particulate material. Alternatively, an article could be formed in layers upward from an immovable platform, by successively depositing, smoothing, and printing a series of such layers.

Referring to FIG. 4, the unactivated particulate material may be removed from the intermediate article 38 by pressurized air flow or a vacuum. After removal of the unactivated particulate material from the intermediate article 38, a post-processing treatment may be performed, such as cleaning, infiltration with stabilizing materials, painting, etc. to define a final article 40, having the same shape as intermediate article 38, but with additional desired characteristics, such as a stiffness, strength, and flexibility.

Infiltration

In an embodiment in which intermediate article 38 is treated by infiltration, intermediate article 38 may be impregnated by a liquid resin infiltrant. Capillary suction is the driving force for the introduction of the infiltrant into the intermediate article and the retention of the infiltrant within the infiltrated article. The absorbent filler assists in the infiltration process by providing increased porosity, permeability, and surface energy to the intermediate article. Porosity is the ratio of the total amount of void space in a material (due to pores, small channels, etc.) to the bulk volume occupied by the material. Permeability is a measure of the effective porosity of pores/channels interconnecting within an article. Surface energy is a measure of the adhesive force of a surface and surface tension is a measure of the cohesive force of the infiltrant. Capillary suction is inversely proportional to the radii of the small channels and pores created by the absorbent filler and is directly proportional to the surface energy of the intermediate article 38. Capillary suction increases when: (i) the pore radii decrease, (ii) the surface energy of the particulate components of the intermediate article 38 increases, or (iii) the surface tension of the infiltrant decreases.

Surface energy is controlled by the careful selection of absorbent fillers or modification of absorbent filler. It is desired to use an absorbent filler with a minimum surface energy of about 30 dynes/cm or greater, which is greater than the surface tension of most infiltrants considered for this embodiment. Preferably, the absorbent filler has a minimum surface energy of about 40 dynes/cm, more preferably about 50 dynes/cm or greater. The surface tension of the infiltrant may be decreased with the addition of surface tension reducing agents. A system that results in the surface energy (adhesive force) of an article being greater than the surface tension (cohesive force) of the infiltrant leads to more complete infiltration and tends to enhance the final mechanical properties of the infiltrated article.

The permeability of the intermediate article 38 enables the infiltrant to travel freely through the intermediate article 38, un-obstructed, and to cover the available surface area provided by the absorbent filler. The permeability of the intermediate article 38 also allows the gas/air entrapped within the porosity of the intermediate article 38 to freely escape and allow the infiltrant to fill in the porosity of the intermediate article 38.

The liquid resin infiltrant may be solidified by one of several methods. The liquid resin infiltrant may be solidified, for example, by a chemical mechanism initiated by heat, UV light, an electron beam, mixing, a catalyst, or moisture by exposure to ambient air. Some examples of combinations of suitable infiltrants and methods for initiating a chemical mechanism to stabilize and solidify the intermediate article 38 are as follows:
Heat
   two part melamine-polyol systems
   two part urethane systems including isocyanate-polyol and isocyanate-amine
   two part epoxy-amine systems
UV light and electron beam
   Acrylates
   Unsaturated polyester resins
   Vinyl ethers
   Acid catalyzed epoxies
Mixing
   Two part urethane systems including isocyanate-polyol and isocyanate-amine
   Two part epoxy-amine systems
   Unsaturated polyester resins and catalysts
   Acid catalyzed epoxies
Catalyst
   Two part melamine-polyol systems
   Two part urethane systems including isocyanate-polyol and isocyanate-amine
   Two part epoxy-amine systems
   Unsaturated polyester resins and catalysts
   Acid catalyzed epoxies
Moisture by exposure to ambient air
   Cyanoacrylate
   Isocyanate terminated urethanes
   Silanes

Alternatively, the liquid resin infiltrant may be solidified by cooling. In some embodiments, the liquid resin infiltrant may be a liquid at a relatively low temperature, e.g., greater than about 50° C. and may be a solid at room temperature. Examples of infiltrants with such characteristics are paraffin wax, polyester, sulfopolyesters, polyamides, polyolefins, polyethylene, polypropylene, polyethylene, polyethylene-co-olefin copolymers, long chain primary alcohols, ethoxylated alcohols, long chain carboxylic acids, oxidized microcrystalline wax, oxidized polyethylene wax, branched polyolefins, unsaturated polyolefins, maleic anhydride grafted polyethylene, maleic anhydride grafted polyolefin, potassium salt oxidized waxes, lithium salt oxidized waxes, urethane derivitized oxidized waxes, and combinations thereof. Finally, the liquid resin infiltrant may be solidified by drying. This method may be appropriate when the infiltrant is applied to the intermediate article 38 in the form of a liquid solution (or dispersion) of a polymer in a solvent, and the solvent is evaporated. Drying may be performed at either room temperature in air, or at temperatures up to about 250° C. in an oven.

In one embodiment, the activating fluid applied to the powder may be a phase-change material. This phase-change material may be used as an adhesive for the particulate material as well as to provide the physical characteristics needed to achieve snap-fit performance by the final article 40. The phase-change material may be a thermoplastic material having a melting point less than about 140° C., but solid at ambient temperatures, i.e., about 20° C. to about 40° C. It may have a low viscosity, e.g., between about 10 to about 30 centipoise (cPs), so that the phase-change material is jettable at a selected temperature above its melting point. This phase-change material may be applied with a piezo printhead supplied with a reservoir and a heater, to keep the material at a low viscosity amenable for printing. Appropriate piezo printheads are manufactured by, e.g., Spectra and Hitachi Printing Solutions of America.

The method of the present invention is capable of producing features having dimensions on the order of about 250 micrometers (μm) or more. The accuracy achieved by the method of the present invention is in the range of about ±250 μm. Shrinkage of the final article 40 is about 1%, which may easily be factored into the build model to increase accuracy. The surface finish is of fine quality, having a porosity of about 50% and a surface roughness of about 200 μm. The final article 40 may have thin walls, with thicknesses of, for example, about 1 millimeter (mm).

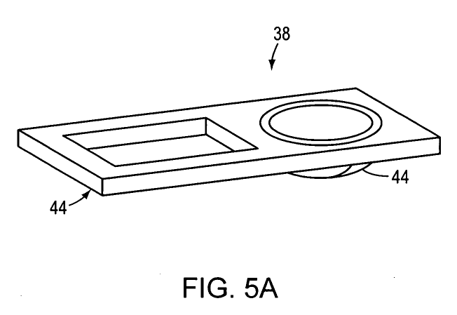

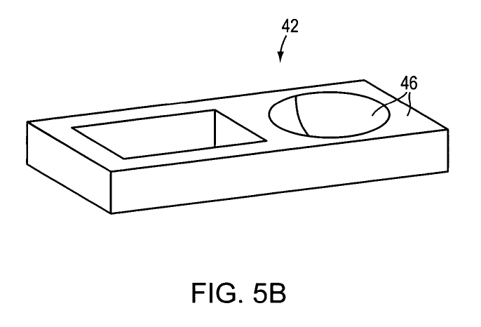

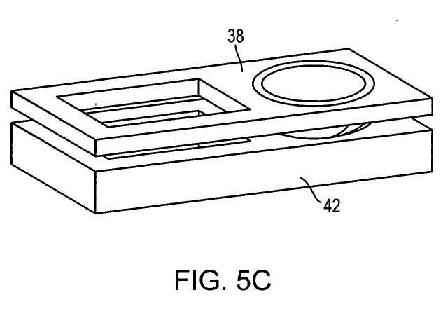

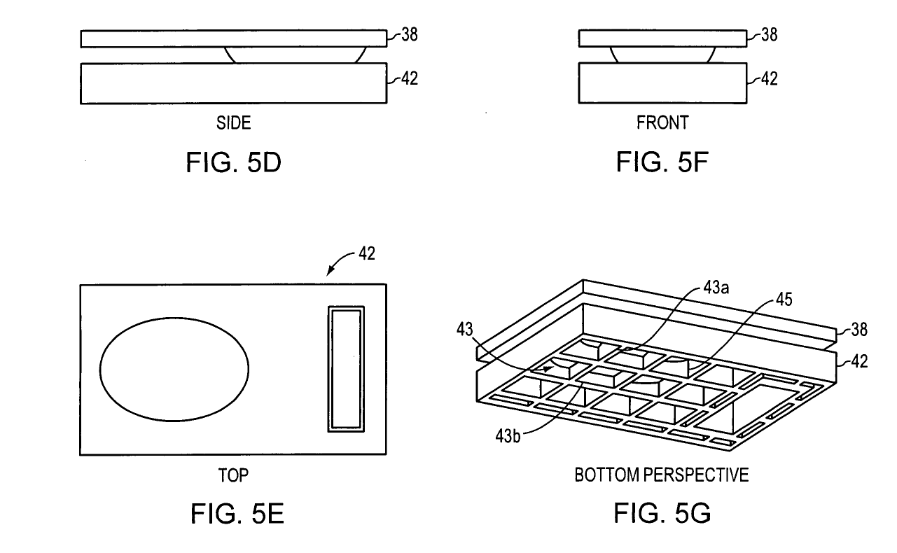

Referring to FIGS. 5a-5g, a support structure 42 may be formed in conjunction with the formation of the intermediate article 38 by three-dimensional printing. The support structure 42 may facilitate removal of the intermediate article 38 from the container 24. Moreover, the support structure 42 may provide structural support to the intermediate article 38 during infiltration and any subsequent heat treatment. Finally, the support structure 42 may also provide support during other stabilization methods, such as curing by UV light, curing by electron beam, and drying in air or in an oven. The support structure 42 may be used in any printing system with unsupported features, as well as with powder systems that are inherently softer with less structural integrity.

The support structure 42 may have a shape complementary to a shape of the intermediate article 38, or a portion thereof. For example, the support structure 42 may have an opening or an indentation corresponding to an opening or an indentation in the intermediate article 38. Software defining the formation of the intermediate article 38 may be used to define simultaneously the support structure 42. More particularly, the support structure 42 may be defined as follows:
1. Software for three-dimensional printing justifies the intermediate article 38 to be built to a bottom margin of the vertical or z-axis of the printer (not shown) in which the ink-jet style nozzle 28 is disposed.
2. The intermediate article 38 is translated a distance, e.g., 0.5 inches, along the z-axis from the bottom margin of the z-axis.
3. Software generates model data for the support structure 42. Referring also to FIG. 5d-5g, the support structure 42 has a top surface that is conformal to and mates with the bottom surface of the intermediate article 38. The bottom surface of the support structure includes a grid 43 of orthogonal walls 43a, 43b oriented parallel to the x- and y-axes, respectively, and can be extruded down to a single plane 45 parallel to the z-axis. Other bottom surface reinforcing configurations will be apparent to those skilled in the art, e.g., honeycomb structures, struts, ribs, I-beams, and the like. The thickness of the conformal surface, wall thickness, and spacing of the walls 43a, 43b in the grid 43 may be selected with the software. The support structure 42 data may be based on geometric data for the intermediate article 38, with slightly greater or lesser dimensions, as required, to provide clearance. This clearance may be selected, for example, from the range of about 0.1 inches to about 0.25 inches, with a wall thickness of about, e.g., 0.1 inches to 0.25 inches and grid spacing of, e.g., between about 0.5 inches to about 1 inch along x- and y-axes.
4. In some embodiments, support structure 42 may be designed to intersect or touch a portion of the intermediate article 38, thereby providing additional support to the intermediate article 38.
5. The intermediate article 38, along with support structure 42, is printed, dried, and depowdered, as described above with reference to FIGS. 1-4.
6. The intermediate article 38 is temporarily separated from the support structure 42. The bottom portions 44 of the intermediate article 38 may be lightly coated with an infiltrant by brushing, spraying, dripping, dipping or other suitable method.
7. A mold release agent or cooking oil is liberally applied onto a top surface 46 of support structure 42, and allowed to soak into support structure 42.
8. The intermediate article 38 is placed to rest on support structure 42, and infiltrant is applied to all exposed surfaces of the intermediate article 38 by brushing, spraying, dripping, dipping, or other suitable method.
9. Intermediate article 38 and support structure 42 are placed into an oven together or otherwise cured, thereby forming the final article 40.
10. The final article 40 and the support structure 42 are removed from the oven or other curing environment. The final article 40 is gently pulled away from the support structure 42, to break any adhesion that may have occurred between the final article 40 and the support structure 42 during curing.
11. The support structure 42 cradles the final article 40 while the final article 40 is allowed to cool at room temperature or at ambient conditions. The final article 40 is permanently removed from the support structure 42 when the final article 40 has cooled and the infiltrating resin is no longer soft.

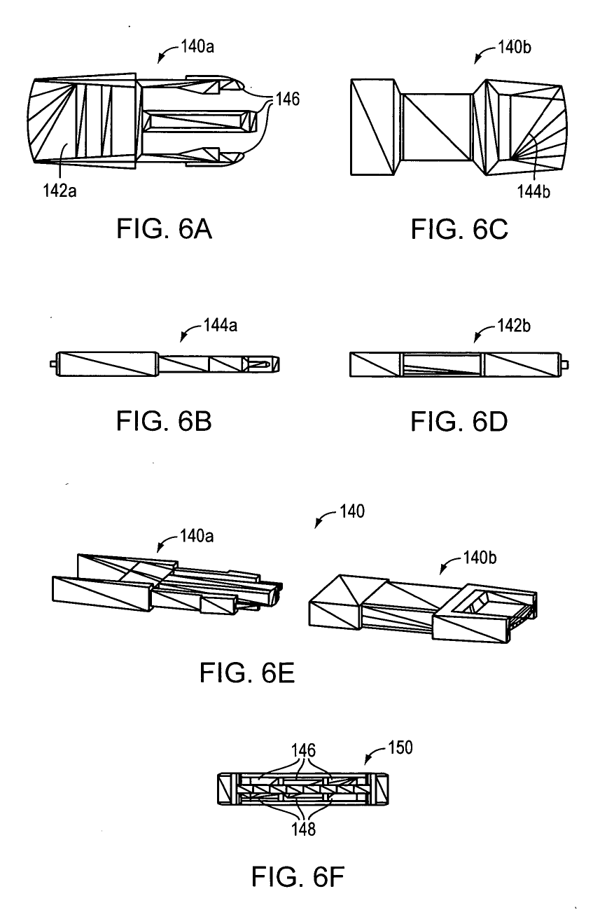

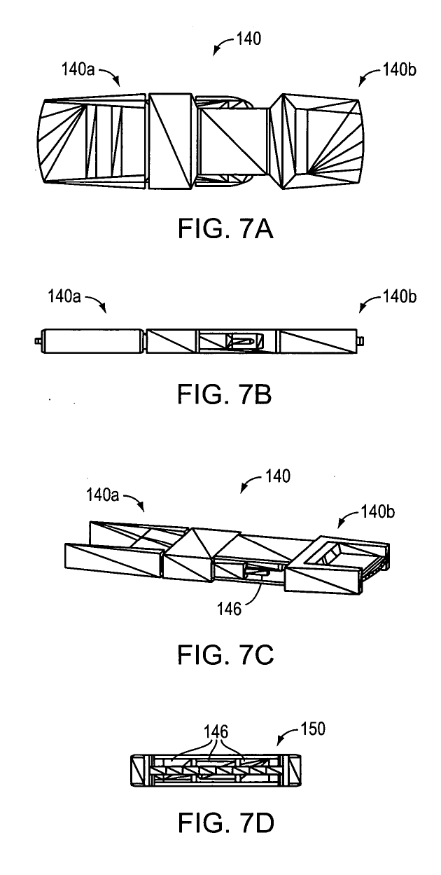

Referring to FIGS. 6a-6f and 7a-7d, a final article 140 formed by the three-dimensional printing methods described above with reference to FIGS. 1-4 may include portions that cooperate with each other to provide a snap fit. The final article 140 may be, for example, a buckle having a male portion 140a and a female portion 140b. The male portion 140a and the female portion 140b may be fabricated simultaneously or separately from a powder containing an absorbent filler.

Referring to FIGS. 6a and 6b, the male portion 140a, having a top surface 142a and a cross-section 144a, has a plurality of tines 146. Referring also to FIGS. 6c-6f and 7a-7d, the tines 146 are configured to resiliently deflect and spring back, to fit snugly within openings 148 of the female portion 140b, having a top surface 142b and a cross-section 146b. A frontal cross-section 150 of the final article 140, therefore, includes both tines 146 defined by the male portion 140a and openings 148 defined by the female portion 140b. The powder of the invention may provide the physical characteristics necessary for achieving a final article with snap fit, such as a large yield point, a long strain to failure, and/or a high energy to break. Typical values may be, for example, yield values of 20 megapascals (MPa) strength at 2% strain with an ultimate strength of 30 MPa at 3.5% strain. The male portion 140a, therefore, snap fits into the female portion 140b of the final article 140.

Powder Constituents

The powder of the invention has a relatively high oil absorption capacity. The capacity for an absorbent filler to retain an infiltrant may best be defined by the oil absorption capacity. Absorption capacity is typically defined in terms of oil or water absorption in units of grams of fluid per 100 grams of dry powder. Oil/water absorption is directly proportional to the surface area of the powder available to the fluid. The surface area of powders may be increased by manufacturing them with rough, irregular surfaces, and/or pores. Alternatively, the particle size may be decreased. In some embodiments, the absorbent filler and other powder constituents may have a particle size range of about 5 μm to about 100 μm and a minimum oil absorption value of about 30 grams of oil per 100 grams of powder. In some embodiments, the particle size may have a range of about 20 μm to about 75 μm and an oil absorption value of about 200 grams per 100 grams of powder to about 500 grams per 100 grams of powder.

Absorbent Filler Material

Absorbent particulate material is a major component of the materials system of the invention. This particulate material may include any of a variety of materials that has a relatively high oil absorption capacity, e.g., about 30 grams to about 500 grams of oil per 100 grams of absorbent material. Preferably, the oil absorption capacity is about 200 grams of oil to about 400 grams per 100 grams of material, and more preferably, about 250 grams of oil to about 350 grams of oil per 100 grams of material.

Some examples of suitable absorbent filler materials are:
1. powdered amorphous cellulose;
2. powdered microcrystalline cellulose;
3. polyamide powder;
4. porous poly-methylmethacrylate powder;
5. ethylene-propylene-diene-monomer (EPDM) powder;
6. zinc oxide;
7. magnesium oxide;
8. calcium sulfate;
9. calcium carbonate;
10. poly condensate of urea-formaldehyde;
11. surface modified ultra high molecular weight polyethylene powder;
12. surface modified high density polyethylene powder;
13. methylenediaminomethylether polycondensate;
14. maltodextrin;
15. aluminum oxide;
16. soda-lime glass;
17. borosilicate glass;
18. amorphous silica;
19. aluminosilicate ceramic;
20. clays such as, but not limited to, montmorillonite and kaolin;
21. fly ash;
22. pigment grade ceramics such as, but not limited to, iron oxide, chromic oxide, titanium dioxide;
23. silica gel;
24. aluminosilicate zeolites; and
   combinations thereof.

In one embodiment, the absorbent filler may include a chemically modified absorbent filler, such as a chemically modified glass bead (e.g., a glass bead containing an amino group or an epoxy group); a chemically modified polyamide powder; or a chemically modified polyethylene powder. Either of the chemically modified polyamide powder and the polyethylene powder may include a carboxylic acid group. The chemical modification allows the surface of the absorbent filler to participate in the chemical reaction of the infiltrant or, alternatively, increases the surface energy of the absorbent filler.

Reactive Filler

The additional filler of the present invention, other than the absorbent particulate filler material, may be a compound selected for the characteristics of partial solubility in the activating fluid, rapid wetting, low hygroscopicity, and the ability to gel or crystallize when wet by the activating fluid. The reactive filler provides mechanical structural integrity to the hardened composition. Sparingly soluble filler material is generally advantageous, but insoluble filler material, or completely soluble filler material may be used. The filler particles become adhesively bonded together when the reactive filler gels or crystallizes after the activating fluid has been applied. The reactive filler typically includes a distribution of particle grain sizes, ranging from a practical maximum diameter of about 100 μm downward, to a practical minimum of about 1 μm. Large grain sizes appear to improve the final article quality by forming large pores in the powder through which the fluid may migrate rapidly, permitting production of a more homogeneous material. Smaller grain sizes serve to reinforce the final article strength. Control of the grain size may also be used to control the rate of gelling or crystallization, by taking into account the fact that materials with smaller grain sizes dissolve more rapidly than materials with large grain sizes. Accordingly, a distribution of grain sizes provides the advantages of both smaller and larger grain sizes.

Various compounds are suitable for use as the reactive filler of the present invention, provided that the solubility, hygroscopicity, and reactivity criteria described above are met. Examples of suitable reactive filler materials include inorganic materials such as plaster, portland cement, magnesium phosphate cement, magnesium oxychloride cement, magnesium oxysulfate cement, zinc phosphate cement, zinc-eugenol cement, and combinations thereof. Portland cement, as defined by American Society for Testing and Materials (ASTM) C 150, is a hydraulic cement (cement that not only hardens by reacting with water but also forms a water-resistant product) produced by pulverizing clinkers consisting essentially of hydraulic calcium silicates, usually containing one or more of the forms of calcium sulfate as an inter ground addition.

Adhesive

The adhesive particulate material may be a compound selected for one or more of the characteristics of high solubility in the activating fluid, low solution viscosity, low hygroscopicity, and high bonding strength. The adhesive is preferably highly soluble in the activating fluid to ensure that it is rapidly and substantially completely incorporated into the fluid. The adhesive is typically milled very finely prior to admixture with the absorbent particulate filler material and/or the reactive filler particles in order to increase the available surface area, enhancing dissolution in the fluid, without being so fine as to cause “caking,” an undesirable article characteristic in which unactivated powder spuriously adheres to the outside surface of the part, resulting in poor surface definition. Typical adhesive particle diameters are about 10 μm to about 100 μm. Low hygroscopicity of the adhesive avoids absorption of excessive moisture from the air, which may also contribute to undesirable caking.

In some embodiments, the adhesive of the present invention is water-soluble, i.e., the adhesive dissolves in an aqueous fluid. Compounds suitable for use as the adhesive of the present invention may be selected from the following non-limiting list: water-soluble polymers, alkaline-reducible resin, carbohydrates, sugars, sugar alcohols, proteins, and some inorganic compounds. Water-soluble polymers with low molecular weights may be preferred, in some embodiments, because they dissolve more quickly due to smaller molecules diffusing more rapidly in solution. Suitable water-soluble polymers include:
1. polyvinyl alcohol;
2. sulfonated polyester polymer;
3. sulfonated polystyrene
4. octylacrylamide/acrylate/butylaminoethyl methacrylate copolymer;
5. acrylates/octylarylamide copolymer;
6. polyacrylic acid;
7. polyvinyl pyrrolidone;
8. styrenated polyacrylic acid;
9. polyethylene oxide;
10. sodium polyacrylate;
11. sodium polyacrylate copolymer with maleic acid;
12. polyvinyl pyrrolidone copolymer with vinyl acetate;
13. butylated polyvinylpyrrolidone;
14. polyvinyl alcohol-co-vinyl acetate;
15. starch;
16. modified starch;
17. cationic starch;
18. pregelatinized starch,
19. pregelatinized modified starch, and
20. pregelatinized cationic starch,
   as well as combinations and copolymers thereof.

The adhesive may include carbohydrates such as starch, cellulose, acacia gum, locust bean gum, pregelatinized starch, cationic starch, maltodextrin, potato starch, acid-modified starch, hydrolyzed starch, sodium carboxymethylcellulose, sodium alginate, hydroxypropyl cellulose, chitosan, carrageenan, pectin, agar, gellan gum, gum Arabic, xanthan gum, propylene glycol alginate, guar gum, and combinations thereof. Suitable sugars and sugar alcohols that may be used include sucrose, dextrose, fructose, lactose, polydextrose, sorbitol, xylitol, cyclodextrans, and combinations thereof. Organic compounds including organic acids may also be used, including citric acid, succinic acid, polyacrylic acid, urea, and combinations thereof. Organic compounds may also include proteins such as gelatin, rabbit-skin glue, soy protein, and combinations thereof. Inorganic compounds may include plaster, bentonite, precipitated sodium silicate, amorphous precipitated silica, amorphous precipitated calcium silicate, amorphous precipitated magnesium silicate, amorphous precipitated lithium silicate, amorphous precipitated silicates containing a combination of two or more of sodium ions, lithium ions, magnesium ions, and calcium ions, salt, portland cement, magnesium phosphate cement, magnesium oxychloride cement, magnesium oxysulfate cement, zinc phosphate cement, zinc oxide-eugenol cement, aluminum hydroxide, magnesium hydroxide, calcium phosphate, sand, wollastonite, dolomite, and combinations thereof.

Salt

In some embodiments, the particulate mixture may contain a salt. The salt may be used to modify the chemical reaction of the reactive filler and/or to control the dissolution characteristics of the adhesive. The salt may include terra alba, potassium sulfate, sodium chloride, undercalcined plaster, alum, potassium alum, lime, calcined lime, barium sulfate, magnesium sulfate, zinc sulfate, calcium chloride, calcium formate, calcium nitrate, sodium silicate, magnesium sulfate monohydrate, potassium, sodium, and ammonium sulfates and chlorides, sodium tetraborate decahydrate, sodium tetraborate pentahydrate, sodium tetraborate anhydrous, zinc borate, boric acid, and combinations thereof.

Fiber

In some embodiments, the particulate mixture may include a reinforcing fiber or a reinforcing fibrous component, added to provide structural reinforcement and structural integrity to the final article. The particulate material may include a plurality of particles of mean diameter of about 10-100 μm. The reinforcing fiber length is generally restricted to a length approximately equal to the thickness of the layer of particulate mixture being printed. The reinforcing fiber length is typically about 60 μm to about 200 μm in length, and is included in an amount not greater than about 50%, by weight, of the total mixture, preferably not greater than about 30%, and more preferably not greater than about 20%.

The reinforcing fiber of the present invention is preferably either insoluble or substantially slower dissolving than the adhesive in the fluid which activates the adhesive. The reinforcing fiber may be a relatively stiff material, chosen to increase the mechanical reinforcement and dimensional control of the final article, without making the powder too difficult to spread. In order to promote wetting of the reinforcing fibers, the chosen fiber advantageously may have a relatively high affinity for the solvent. In one embodiment, a fiber length is approximately equal to the layer thickness, which provides a substantial degree of mechanical reinforcement. Using longer fibers tends to adversely affect the surface finish, and using too much fiber of any length can make spreading the powder increasingly difficult. Fibrous material suitable for reinforcing the present invention includes, but is not limited to, cellulose, polymeric fiber, ceramic fiber, graphite fiber, fiberglass, and combinations thereof. The polymeric fiber may be cellulose and cellulose derivatives or substituted or unsubstituted, straight or branched, alkyl or alkene monomers containing up to eight carbon atoms. Specific useable fibrous materials include, but are not limited to, natural polymers, modified natural polymers, synthetic polymers, ceramic, cellulose fiber, silicon carbide fiber, graphite fiber, aluminosilicate fiber, polypropylene fiber, fiberglass, polyamide flock, cellulose, rayon, polyvinylalcohol, and combinations thereof.

In some embodiments, a stabilizing fiber may be added to the filler to provide dimensional stability to the final article, as well as to increase slightly the article strength. Spreading the particulate mixture with the counter-roller becomes increasingly difficult as friction caused by an excess of stabilizing fiber in the mixture increases, reducing the packing density. Therefore, limiting both the amount and length of the stabilizing fiber typically increases the packing density of the mixture, resulting in finished parts of greater strength. In general, the stabilizing fiber is restricted to a length of less than about half of the reinforcing fiber, in an amount not greater than about 50 percent by weight, of the total mixture, preferably not greater than about 40 percent by weight, and more preferably not greater than about 30 percent by weight. Optimal values may be determined in practice using, for example, a counter-roller.

Both the reinforcing fiber and the stabilizing fiber may be cellulose. Some of the useful properties of cellulose, making it particularly suitable for use in connection with the invention, are low toxicity, biodegradability, low cost, and availability in a wide variety of lengths.

Further considerations in selecting the absorbent filler particulate material, reactive filler, adhesive, and fiber depend on the desired properties of the final article. The final strength of the finished article depends not insubstantially on the quality of the adhesive contacts between the particles of the mixture, and the size of the empty pores that persist in the material after the adhesive has hardened; both of these factors vary with the grain size of the particulate material. In general, the mean size of the grains of particulate material is preferably not larger than the layer thickness. A distribution of grain sizes increases the packing density of the particulate material, which in turn increases both article strength and dimensional control.

Processing Aid

A processing aid for three-dimensional printing is typically a viscous liquid component of the powder material system. It may be a liquid polymer or a polymer having a low melting point. Preferably, it is non-aqueous, thereby not reacting with water-soluble powder components. By loosely bonding the powder, the processing aid keeps the layers from shifting during spreading. The processing aid may also act as a wetting agent, attracting the fluid and allowing the fluid to spread rapidly. Further, the processing aid may reduce dust formation. Examples of materials that may be used as processing aids include polyethylene glycol, polypropylene glycol (PPG), sorbitan monolaurate, sorbitan monooleate, sorbitan trioleate, polysorbate, poly(ethylene oxide) modified silicone, poly(propylene oxide) modified silicone, secondary ethoxylated alcohols, ethoxylated nonylphenols, ethoxylated octylphenols, C₈-C₁₀ alcohols, C₈-C₁₀ acids, polyethylene oxide modified acetylenic diols, citronellol, ethoxylated silicones, ethylene glycol octanoate, ethylene glycol decanoate, ethoxylated derivatives of 2,4,7,9-tetramethyl-5-decyne-4,7-diol, polyoxyethylene sorbitan mono-oleate, polyethylene glycol, soybean oil, mineral oil, fluroalkyl polyoxyethylene polymers, glycerol triacetate, oleyl alcohol, oleic acid, squalene, squalane, essential oils, esters, terpenes, greases, waxes, propylene glycol, ethylene glycol, C₈-C₁₀ esters of mono, di, or triglycerides, fatty acids, ethoxylated fatty acids, lecithin, modified lecithins, and combinations thereof.

Activating Fluid

The fluid of the present invention is selected to comport with the degree of solubility required for the various particulate components of the mixture, as described above. Relatively low solution viscosity ensures that once the adhesive is dissolved in the activating fluid, the fluid migrates quickly to sites in the powder bed to adhesively bond together the absorbent and reactive filler and reinforcing materials.

First Solvent

The fluid may include water as a first solvent.

Second Solvent (Humectant)

A second solvent (humectant) having a boiling point that may be higher than a boiling point of the first solvent, i.e., water, may be included in the fluid to retard evaporation of the fluid from the printed material, and to prevent drying/clogging of the printhead delivery system. The second solvent may be water-miscible and may include, for example, butyrolactone, glycerol carbonate, propylene carbonate, ethylene carbonate, dimethyl succinate, dimethyl sulfoxide, n-methylpyrrolidone, glycerol, 1,4 butanediol, polyethylene glycol, diethylene glycol butyl ether, ethylene glycol, diethylene glycol, propylene glycol, polypropylene glycol, polyethylene glycol ethers, polypropylene glycol ethers, tetraethyleneglycol ethers, and combinations thereof.

Surfactant

A surfactant may be added to the fluid to reduce its surface tension, thereby assisting it in slipping through the jets of the printhead. The surfactant may be, for example, polyethylene oxide modified acetylenic diols, secondary ethoxylated alcohols, ethoxylated nonylphenols, ethoxylate silicones, ethoxylated fluorinated surfactants, ethoxylated tetramethyldecynediol, ethoxylated tetramethyldodecynediol, polyethermodfied polysiloxanes, ethoxylated sorbitan monolaurate, octyl phenoxypolyethoxy-polypropoxy-propanol, sulfonated fatty acids, zwitterionic betaines, sodium di-octyl sulfosuccinate, dimethyl dodecylammoniopropane sulfonate, ethylene glycol diacetate, diethyl succinate, dimethyl tartrate, n-octyl pyrrolidone, glycerol propoxylate, terpinyl acetate, propyl propionate, and combinations thereof.

Rheology Modifier

A rheology modifier may be added to the fluid to increase viscosity, thereby increasing the efficiency of the printhead and aiding printing. Examples of possible rheology modifiers include polyvinylpyrrolidone, polyacrylamide, polyethylene oxide, hydrophobe modified ethoxy urethanes, polyvinyl alcohol, polyacrylic acid, polymethacrylic acid, alkali and ammonium salts of polyacrylic acid, alkali and ammonium salts of polymethacrylic acid, polyvinylpyrrolidone-co-vinyl acetate, butylated polyvinylpyrrolidone, polyvinylalcohol-co-vinyl acetate, and polyacrylic acid-co-maleic anhydride, and combinations and copolymers thereof.

Amines

Amines may be added to the fluid to assist in the dissolution of water-miscible adhesives, such as water-soluble resins. Examples of suitable amines include monoisopropanol amine, triethylamine, 2-amine-2-methyl-1-propanol, 1-amino-2-propanol, 2-dimethylamino-2-methyl-1-propanol, N,N-diethylethanolamine, N-methyldiethanolamine, N,N-dimethylethanolamine, triethanolamine, 2-aminoethanol, 1-[bis[3-(dimethylamino)propyl]amino]-2-propanol, 3-amino-1-propanol, 2-(2-aminoethylamino)ethanol, tris(hydroxymethyl)aminomethane, 2-amino-2-ethyl-1,3-propanediol, 2-amino-2-methyl-1,3-propanediol, diethanolamine, 1,3-bis(dimethylamino)-2-propanol, polyethylenimine, and combinations thereof.

Biocides

A biocide may be added to the fluid to control the growth of micro organisms such as mold, yeast, and bacteria. Typical classes of biocides include, but are not limited to,
1. chlorine and chlorine compounds;
2. iodine and iodine compounds;
3. peroxygen compounds;
4. ozone;
5. chlorine dioxide;
6. alcohols;
7. phenolic compounds;
8. surfactants;
9. chlorhexidine;
10. glutaraldehyde;
11. nitrogen compounds;
12. parabens; and
13. isothiozolinones.

Biocides may be used individually or in combinations, depending on the biocidal properties desired. Specific examples of biocides include 1,2-benzisothiazolin-3-one, bromo-nitro-propanediol, dimethyloxazolidine, glutaraldehyde, iodophor, methyl paraben, potassium sorbate, quaternary ammonia, sodium benzoate, tetrachloroisopthalonitrile, and zinc pyrithione.

Typical compositions of embodiments of the powder of the invention, as well as appropriate activating fluids, are given in Table 1:

TABLE 1
Typical powder and fluid constituents
Typical Formulation 1

| Powder | | Range | |
|---|---|---|---|
| constituent | Material | (weight) | typical |
| Reactive filler | plaster | 50-70 | 60 |
| Adhesive | PVA | 10-20 | 12 |
| Absorbent filler | maltodextrin | 0-5 | 3 |
| Absorbent filler | powdered cellulose | 20-30 | 23 |
| Salt | terra alba | 0-2 | 1 |
| Salt | potassium sulfate | 0-2 | 1 |
| Fluid | | Range | |
| constituent | Material | (weight) | typical |
| first solvent | water | 85-95 | 93.9 |
| Second solvent | glycerol | 0-10 | 5 |
| (humectant) | | | |
| Surfactant | ethoxylated | 0-1 | 0.1 |
| | tetramethyldecynediol | | |
| Biocide | potassium sorbate | 0-1 | 0.5 |
| Rheology | polyvinylpyrrolidone | 0-5 | 0.5 |
| modifier | | | |

Typical Formulation 2

| Powder | | Range | |
|---|---|---|---|
| Constituent | Material | (weight) | typical |
| Reactive filler | plaster | 50-70 | 59 |
| Adhesive | PVA | 10-20 | 15 |
| Absorbent filler | powdered cellulose | 20-30 | 25 |
| Salt | terra alba | 0-2 | 0.5 |
| Processing aid | polypropylene glycol | 0-2 | 0.5 |
| Fluid | | Range | |
| constituent | Material | (weight) | Typical |
| First solvent | water | 90-98 | 92.9 |
| Second solvent | glycerol | 0-10 | 5 |
| (humectant) | | | |
| Salt | potassium sulfate | 0-2 | 2 |
| Surfactant | ethoxylated | 0-1 | 0.1 |
| | tetramethyldecynediol | | |

Phase-Change Material

In some embodiments, the activating fluid may be a phase-change material, such as a hot melt thermoplastic material. The phase-change material may provide physical characteristics desirable for forming final articles with snap fit. The phase-change material may be, for example, a thermoplastic material such as a urethane, a polyamide, a polyester, an ethylene vinyl acetate, parrafin, a polyethylene wax, a polyolefin wax (e.g., a polypropylene wax), a styrene-isoprene-isoprene copolymer, a styrene-butadiene-styrene copolymer, an ethylene ethyl acrylate copolymer, a polyoctenamer, a polycaprolactone, an alkyl cellulose, a hydroxy alkyl cellulose, a polyethylene/polyolefin copolymer, a maleic anhydride grafted polyethylene or polyolefin, an oxidized polyethylene, a potassium or lithium salt of an oxidized polyethylene, a urethane derivitized oxidized polyethylene, a long chain primary alcohol, a long chain carboxylic acid, a branched polyolefin, an unsaturated polyolefin, and combinations thereof.

Flowrate Enhancer

The fluid may include a processing aid such as a flowrate enhancer. The flowrate enhancer may have some humectant properties, but serves mainly to alter the hydrodynamic properties or wetting characteristics of the fluid to maximize the volume of fluid delivered by the printhead. Flowrate enhancement is thought to be a viscoelastic phenomena increasing the flow rate of the fluid, allowing thicker layers to be printed, thus allowing the final article to be built more quickly. Preferred compounds that increase the flowrate of the fluid, either by reducing friction between the fluid and the walls of the jet, or by reducing the viscosity of the fluid, include ethylene glycol diacetate, potassium sorbate, and potassium aluminum sulfate. Other suitable compounds for use as the flowrate enhancer can be selected from the following non-limiting list: isopropyl alcohol, ethylene glycol monobutyl ether, diethylene glycol monobutyl ether, dodecyl dimethylammoniopropane sulfonate, glycerol triacetate, ethyl acetoacetate, and water-soluble polymers including polyvinyl pyrrolidone with a molecular weight of about 30,000 units, polyethylene glycol, polyacrylic acid, and sodium polyacrylate.

Dyes and Pigments

The fluid of the present invention preferably includes a dye or pigment to provide a visual aid to the operator while building the article. The dye or pigment provides contrast between activated and unactivated powder, which allows the operator to monitor the printed layers while building the article. The dye or pigment can be selected from the group including, but not limited to, naphthol blue black, direct red, and dispersions of anionically surface-modified organic pigments like copper phthalocyanine and carbon black. Numerous other dyes and pigments compatible with the fluid will be known to those skilled in the art.

The materials and method of the present invention present numerous advantages over prior three-dimensional printing methods. The materials used in the present invention are inexpensive, and allow the production of strong, thin-walled articles having exceptional surface finishes. Further, the activating fluid may contain a component having a high boiling point that prevents the jets of the printhead from drying out prematurely.

The equipment used in the method of the present invention is reliable, inexpensive, and easy to maintain, making it ideal for use in an office environment. The materials used in the present invention are highly compatible with ink-jet technology. Thus, less equipment maintenance is required, and the reliability and yield of the equipment is increased. Therefore, the method of the present invention involves shorter build times and less labor than prior art methods.

Those skilled in the art will readily appreciate that all parameters listed herein are meant to be exemplary and actual parameters depend upon the specific application for which the methods and materials of the present invention are used. It is, therefore, to be understood that the foregoing embodiments are presented by way of example only and that, within the scope of the appended claims and equivalents thereto, the invention may be practiced otherwise than as specifically described.

1. A powder for three-dimensional printing, the powder comprising:
an absorbent filler; and
a reactive filler.

2. The powder of claim 1, wherein the absorbent filler is selected from the group consisting of powdered amorphous cellulose, powdered microcrystalline cellulose, polyamide powder, porous poly-methylmethacrylate powder, ethylene-propylene-diene-monomer (EPDM) powder, zinc oxide, magnesium oxide, calcium sulfate, calcium carbonate, surface modified ultra high molecular weight polyethylene powder, surface modified high density polyethylene powder, methylenediaminomethylether polycondensate, maltodextrin, aluminum oxide, soda-lime glass, borosilicate glass, amorphous silica, aluminosilicate ceramic, clays, fly ash, silica gel, pigment grade ceramics, and combinations thereof.

3. The method of claim 2, wherein the clay is selected from the group consisting of montmorillonite and kaolin.

4. The method of claim 2, wherein the pigment grade ceramic is selected from the group consisting of iron oxide, chromic oxide, titanium dioxide, and combinations thereof.

5. The powder of claim 1, wherein the absorbent filler comprises a material having an oil absorption capacity within a range of about 30 grams to about 500 grams of oil per 100 grams of absorbent filler.

6. The powder of claim 1, wherein the absorbent filler comprises a material that is chemically active with an infiltrant.

7. The powder of claim 1, wherein the absorbent filler comprises a chemically modified absorbent filler selected from the group consisting of a chemically modified glass bead, a chemically modified polyamide powder, a chemically modified polyethylene powder, and combinations thereof.

8. The powder of claim 7, wherein the chemically modified glass bead comprises a material selected from the group consisting of an amino group, an epoxy group, and combinations thereof.

9. The powder of claim 7, wherein at least one of the chemically modified polyamide powder and the polyethylene powder comprises a carboxylic acid group.

10. The powder of claim 1, wherein the reactive filler is selected from the group consisting of plaster, portland cement, magnesium phosphate cement, magnesium oxychloride cement, magnesium oxysulfate cement, zinc phosphate cement, zinc eugenol cement, and combinations thereof.

11. The powder of claim 1, further comprising:
an adhesive.

12. The powder of claim 11, wherein the adhesive is selected from the list of water-soluble polymers, carbohydrates, sugars, sugar alcohols, organic acids, proteins, inorganic compounds, and combinations thereof.

13. The powder of claim 12, wherein the water-soluble polymer is selected from the group consisting of polyvinyl alcohol, sulfonated polystyrene, sulfonated polyester, polyethylene oxide, polyacrylic acid, octylacrylamide/acrylate/butylaminoethyl methacrylate copolymer, acrylates/octylarylamide copolymer, polyvinyl pyrrolidone, styrenated polyacrylic acid, polyethylene oxide, sodium polyacrylate, sodium polyacrylate copolymer with maleic acid, polyvinyl pyrrolidone copolymer with vinyl acetate, butylated polyvinylpyrrolidone, polyvinyl alcohol-co-vinyl acetate, starch, modified starch, cationic starch, pregelatinized starch, pregelatinized modified starch, pregelatinized cationic starch, and combinations and copolymers thereof.

14. The powder of claim 1, further comprising:
a salt.

15. The powder of claim 14, wherein the salt is selected from the group consisting of terra alba, potassium sulfate, sodium chloride, undercalcined plaster, alum, potassium alum, lime, calcined lime, barium sulfate, magnesium sulfate, zinc sulfate, calcium chloride, calcium formate, calcium nitrate, sodium silicate, magnesium sulfate monohydrate, potassium sulfate, sodium sulfate, ammonium sulfate, potassium chloride, sodium chloride, ammonium chloride, sodium tetraborate decahydrate, sodium tetraborate pentahydrate, sodium tetraborate anhydrous, zinc borate, boric acid, and combinations thereof.

16. A method for forming an article by three-dimensional printing, the method comprising:
providing a powder comprising a plurality of adjacent particles; and
applying to at least some of the plurality of particles a phase-change material including a thermoplastic material, wherein the thermoplastic material is adapted to
(i) undergo a phase change at a temperature greater than ambient temperature, and
(ii) solidify at ambient temperature, thereby binding those particles to form the article.

17. The method of claim 16, wherein the thermoplastic material is selected from the group consisting of a urethane, a polyamide, a polyester, an ethylene vinyl acetate, parrafin, a polyethylene wax, a polyolefin wax, a styrene-isoprene-isoprene copolymer, a styrene-butadiene-styrene copolymer, an ethylene ethyl acrylate copolymer, a polyoctenamer, a polycaprolactone, an alkyl cellulose, a hydroxy alkyl cellulose, a polyethylene/polyolefin copolymer, a maleic anhydride grafted polyethylene, a maleic, an anhydride grafted polyolefin, an oxidized polyethylene, a potassium salt of an oxidized polyethylene, a lithium salt of an oxidized polyethylene, a urethane derivitized oxidized polyethylene, a long chain primary alcohol, a long chain carboxylic acid, a branched polyolefin, an unsaturated polyolefin, and combinations thereof.

18. The phase-change material of claim 17, wherein the polyolefin wax comprises a polypropylene wax.

19. A method for forming an article by three-dimensional printing, the method comprising the steps of:
providing a powder comprising a plurality of adjacent particles, the powder comprising an absorbent filler selected from the group consisting of powdered amorphous cellulose, powdered microcrystalline cellulose, polyamide powder, porous poly-methylmethacrylate powder, ethylene-propylene-diene-monomer (EPDM) powder, zinc oxide, magnesium oxide, calcium sulfate, calcium carbonate, surface modified ultra high molecular weight polyethylene powder, surface modified high density polyethylene powder, methylenediaminomethylether polycondensate, maltodextrin, aluminum oxide, soda-lime glass, borosilicate glass, amorphous silica, aluminosilicate ceramic, clay, fly ash, silica gel, pigment grade ceramic, and combinations thereof, and
applying to at least some of the plurality of particles a fluid in an amount sufficient to bond those particles together to define the article.

20. The method of claim 19, wherein the absorbent filler has an oil absorption capacity selected from the range of about 30 grams of oil per 100 grams of material to about 500 grams of oil per 100 grams of material.

21. The method of claim 20, wherein the absorbent filler has an oil absorption capacity selected from the range of about 200 grams of oil per 100 grams of material to about 400 grams of oil per 100 grams of material.

22. The method of claim 21, wherein the absorbent filler has an oil absorption capacity selected from the range of about 250 grams of oil per 100 grams of material to about 350 grams of oil per 100 grams of material.

23. The method of claim 19, wherein the clay is selected from the group consisting of montmorillonite, kaolin, and combinations thereof.

24. The method of claim 19, wherein the pigment grade ceramic is selected from the group consisting of iron oxide, chromic oxide, titanium dioxide, and combinations thereof.

25. A method for forming a substantially solid article by three-dimensional printing, the method comprising the steps of:
providing a powder comprising a plurality of adjacent particles;
applying to at least some of the plurality of particles a fluid in an amount sufficient to bond those particles together to define a porous singular intermediate article; and
infiltrating the intermediate article with an infiltrant to define the substantially solid final article having approximately 20%-70% infiltrant by volume.

26. The method of claim 25, wherein the powder comprises an absorbent filler.

27. The method of claim 26, wherein the absorbent filler is selected from the group consisting of powdered amorphous cellulose, powdered microcrystalline cellulose, polyamide powder, porous poly-methylmethacrylate powder, ethylene-propylene-diene-monomer (EPDM) powder, zinc oxide, magnesium oxide, calcium sulfate, calcium carbonate, poly condensate of urea formaldehyde, surface modified ultra high molecular weight polyethylene powder, surface modified high density polyethylene powder, methylenediaminomethylether polycondensate, maltodextrin, aluminum oxide, soda-lime glass, borosilicate glass, amorphous silica, aluminosilicate ceramic, clay, fly ash, silica gel, aluminosilicate zeolite, pigment grade ceramic, and combinations thereof.

28. The method of claim 27, wherein the clay is selected from the group consisting of montmorillonite, kaolin, and combinations thereof.

29. The method of claim 27, wherein the pigment grade ceramic is selected from the group consisting of iron oxide, chromic oxide, titanium dioxide, and combinations thereof.

30. The method of claim 26, wherein the powder comprises a reactive filler.

31. The method of claim 25, wherein the particles have a mean diameter of about 10 micrometers to about 100 micrometers.

32. A method for forming a substantially solid article by three-dimensional printing, the method comprising the steps of:
providing a powder comprising a plurality of adjacent particles;
applying to at least some of the plurality of particles a fluid in an amount sufficient to bond those particles together to define a porous singular intermediate article and a support structure adapted to support the intermediate article; and
infiltrating the intermediate article with an infiltrant to define the substantially solid final article while the intermediate article is supported by the support structure.

33. The method of claim 32, further comprising:
separating the support structure from the intermediate article.

34. The method of claim 33, wherein the support structure is separated from the intermediate article subsequent to infiltration of the intermediate article with the infiltrant.

35. The method of claim 33, wherein the support structure is separated from the intermediate article prior to infiltration of the intermediate article with the infiltrant.

36. The method of claim 32, further comprising:
coating a surface of the support structure with a material adapted to facilitate separation of the support structure from the infiltrated intermediate article.

37. The method of claim 32, further comprising:
heat treating the intermediate article while the intermediate article is supported by the support structure.

38. The method of claim 37, further comprising:
separating the support structure from the substantially solid final article.

39. A substantially solid article comprising:
a conglomerate of
a powder, and
a fluid that binds the powder to define a porous structure; and
an infiltrant disposed within the porous structure to form the substantially solid article having about 20% to about 70% infiltrant by volume,
wherein the article includes a plurality of adjacent layers formed by the conglomerate, each layer having a contour defining an edge, and a final shape of the article being defined by respective edges of the layers.

40. The article of claim 39, wherein the powder comprises an absorbent filler material.

41. The article of claim 40, wherein the powder comprises a reactive filler material.

42. An activating fluid for three-dimensional printing, the fluid comprising:
a first solvent;
a second solvent; and
a biocide.

43. The fluid of claim 42, wherein the biocide is selected from the group consisting of chlorine, a chlorine compound, iodine, an iodine compound, a peroxygen compound, ozone, chlorine dioxide, an alcohol, a phenolic compound, a surfactant, chlorhexidine, glutaraldehyde, a nitrogen compound, a paraben, an isothiozolinone, and combinations thereof.
